(19) United States
(12) Patent Application Publication
(10) Pub. No.: US 2009/0109033 A1
(43) Pub. Date: Apr. 30, 2009

(54) Medical System And Tracking Device

(76) Inventor: Roberto Salvat, Palm Beach Gardens, FL (US)

Correspondence Address: MCHALE & SLAVIN, P.A., 2855 PGA BLVD, PALM BEACH GARDENS, FL, 33410, US

(21) Appl. No.: 12/199,423

(22) Filed: Aug. 27, 2008

Related U.S. Application Data
(63) Continuation-in-part of application No. 11/861,858, filed on Sep. 26, 2007.

(51) Int. Cl. G08B 13/14

(52) U.S. Cl. 340/572.1

(57) ABSTRACT

A tracking device and system for tracking medical supplies, in particular, medical trays and their components is disclosed. The tracking device utilizes GPRS/GSM/CDMA/Wi-Fi/AGPS technology to enable an individual to locate and monitor the movement of a medical tray at any given time and for any desired period of time. The tracking system utilizes geo-fences established around buildings or Wi-Fi or RFID to assist in determining the specific location within a building of the medical trays, as well as the status of the items that may be inside of them. The tracking devices can be activated and deactivated to conserve power and battery life. The tracking devices can also be activated by sensors to alert the tracking system of a housing breach, a possible theft or misplacement of the tray. The tracking system incorporates software which enables an individual to determine the location of medical trays, determine the contents of the trays and schedule the use of the medical trays by specific doctors and at specific locations. The tracking system also retains information regarding the doctors, the medical device manufacture representatives, the hospitals and sales of the medical devices.

### RELATED APPLICATIONS

This application is a continuation-in-part of application Ser. No. 11/861,858, filed Sep. 26, 2007, entitled MEDICAL SYSTEM AND TRACKING DEVICE, the entirety of which is incorporated herein by reference.

### FIELD OF THE INVENTION

The present invention relates to medical supplies and in particular to an apparatus and system for tracking and locating these medical supplies.

### BACKGROUND OF THE INVENTION

Recent advances in medical technology and procedures have yielded a number of devices including spinal implants; hip, knee, shoulder and other orthopedic replacements; pacemakers and other implantable devices. These devices are very costly and normally require the presence of a manufacture's representative to assist the surgeon in utilizing the device properly. These devices are shipped from the manufacture to the hospital in surgical trays. These surgical trays include the medical device and any other equipment required during the medical procedure to install or implant the device. The cost of these medical devices and related equipment is very high, usually exceeding tens of thousands of dollars. This has resulted in a black market for these medical devices.

These surgical trays, including the medical devices, must be available when the surgeon is scheduled to perform the operation. In many instances, like hip and knee replacement, the medical devices are specifically sized for the individual patient. Therefore, an inventory of these devices cannot be maintained in the hospital. If the specific surgical tray required for a surgery cannot be located, the surgery must be postponed. This results in unnecessary costs on behalf of the surgeon and hospital. In addition, these surgical trays, including all of their components, must be sterilized prior to their use.

Another problem is theft of the trays between the manufacturing facility and the operating room. Once the surgical tray is delivered to the hospital and someone accepts shipment, the surgical tray becomes the property and responsibility of the hospital. There have also been instances of theft within the hospitals. In some instances the trays have been shipped to the incorrect hospital and this has not been discovered until the day of the surgery. This shipping error will again result in postponement of the surgery and related expenses.

Therefore, what is needed in the art is a tracking device and system for tracking these surgical trays and other medical supplies from the manufacturer to the operating room. This would enable the medical device manufacture's field representative to locate and monitor the surgical tray containing the medical device from the time is left the manufacturing facility until it arrived in the operating room. The system is also capable of ordering additional supplies and billing for the use of the medical supplies and equipment.

### DESCRIPTION OF THE PRIOR ART

U.S. Published Patent Application No. 2006/0017545 discloses a tracking system for monitoring the location of an object or a group of objects using RFID tags. These tags must be passed by an interrogator or tracking device to be detected. If the RFID devices are not within the range of the tracking devices, such an in a hospital store room, the tracking devices are unable to located the RFID devices. Some of these RFID tags can include a GPS feature to report their location. However, if the tags cannot communicate with the GPS satellites, such as when they are located within buildings, their location cannot be determined. Therefore, this system is not practical when tracking medical trays in hospitals.

U.S. Pat. No. 7,158,754, issued to Anderson and U.S. Pat. No. 7,158,030, issued to Chang, both disclose RFID tags which can be encapsulated on or attached to medical devices. These tags can only be tracked when they are passed by an interrogator or other tracking device. They cannot be located by tracking devices positioned outside of the building when they are within the building.

### SUMMARY OF THE INVENTION

Briefly, the present invention is directed toward a tracking device and system for tracking objects such as medical supplies and in particular, medical trays and their components. Any type of object, person or animal can be tracked or located utilizing the tracking device and system of the present invention. The tracking device of the present invention utilizes GPRS/GSM/CDMA/AGPS method/Wi-Fi technology to enable an individual or automated tracking service to locate and monitor the movement of a surgical tray at any given time and for any desired period of time. The tracking system utilizes geo-fences that are established around or proximate buildings to assist in determining the specific location of the surgical trays when they arrive at these buildings. Whenever a surgical tray passes one of these geo-fences the tracking device is activated and a signal is sent to an individual or device monitoring the location of the surgical tray. The tracking devices can also be activated by motion sensors to alert the tracking system of a possible theft of the surgical tray. The tracking system can also be programmed so the tracking device transmits its position at specific time intervals or constant if needed. An improved tracking system turns off the tracking device whenever the tracking device is not able to communicate with a tracking system and puts the device into hibernation in order to minimize power discharge. For example when the tracking device is on an airplane an altimeter sensor activates the hibernation or sleep mode. This helps conserve battery life. The tracking device can also utilize other wireless communications such as Bluetooth or Wi-Fi to notify the end user of Wi-Fi hotspots or checkpoint it has passed in-transit. The Wi-Fi feature can also enable the device to transmit its location within a building and send this information to a web-based server. This Wi-Fi feature also helps to conserve the battery. Another method for locating the device inside of the building or room, as well monitoring the status of the contents inside the tray is interfacing with RFID. This information can be transmitted several ways to include CDMA, GSM and through the Wi-Fi infrastructure supported in the building.

The tracking device is normally attached to a surgical tray in a manner such that only the individual who installed the tracking device or company providing the tracking service can properly remove the tracking device. This prevents the tracking device from being removed from the surgical tray and left at a known location, such as the store room of a hospital, while the surgical tray is stolen. Normally the only time the tracking device needs to be removed from the surgical tray is to replace the batteries or to perform maintenance on the tracking device. The tracking device can also be equipped with a pager or beeper to assist in determining its location in large store rooms.

The tracking device is also weather/water proof and capable of withstanding elevated temperatures, such as those encountered in an autoclaving process. The tracking device includes a shock and heat absorption insulation system to protect the device.

Accordingly, it is an objective of the instant invention to provide a system for tracking a medical device tray or non-sterile container and its contents at all locations including inside of buildings. These contents may or may not include implants, instruments, biologics and medical equipment used in and out of the operating room or hospital.

It is a further objective of the instant invention to provide a tracking device which can withstand the medical instruments sterilization environments.

It is yet another objective of the instant invention to provide a system for tracking medical devices which includes information regarding the intended user of the devices, information of the unit's related contents and how to use them, the location and time at which the devices are to be used and the representative of the device manufacturer.

It is a still further objective of the invention to enable the medical devices to be ordered and shipped to the desired locations including the actual operating room within the hospital in which the device and its contents are to be used when required.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIGS. 1A-D are an overall flow chart of the various aspects of the data base and how they are connected;

FIGS. 2A-D are a flowchart similar to FIG. 1 with some additional information;

FIG. 3 is a web page of the system illustrating the scheduling of surgeries;

FIG. 4 is a web page of the system illustrating how data is entered regarding medical devices representatives;

FIG. 5 is a web page illustrating the color codes on the charge sheet;

FIG. 6 is a web page for entering hospital data;

FIG. 7 is a web page for obtaining hospital data;

FIG. 8 is a web page illustrating medical device information;

FIG. 9 is a web page for entering surgical procedure information;

FIG. 10 is a web page illustrating a schedule of surgeries;

FIG. 11 is a web page illustrating surgeons information;

FIG. 12 is a web page illustrating medical tray availability;

FIG. 13 is a web page illustrating inventory orders for medical trays;

FIG. 14 is a web page illustrating the location of medical trays;

FIGS. 15 A-C illustrate an embodiment of a tracking device for a medical tray;

FIGS. 16 A-C illustrate another embodiment of a tracking device for a medical tray;

FIG. 17 illustrates another embodiment of a tracking device for a medical tray;

FIG. 18 is a side view of another embodiment of a tracking device for a medical tray;

FIG. 19 is an end view of the tracking device illustrated in FIG. 18;

FIG. 20 is a side view of the tracking device illustrated in FIG. 18 with a different medical tray;

FIG. 21 is the tracking device illustrated in FIG. 18 without a medical tray;

FIG. 22 is the underside of the tracking device illustrated in FIG. 21;

FIG. 23 is a further embodiment of a tracking device for a medical tray;

FIG. 24 is a further embodiment of a tracking device for a medical tray and

FIG. 25 are two medical trays with tracking devices connected on the bottoms stacked one above the other for transportation.

### DETAILED DESCRIPTION OF THE INVENTION

While the present invention is susceptible of embodiment in various forms, there is shown in the drawings and will hereinafter be described a presently preferred, albeit non-limiting, embodiment with the understanding that the present disclosure is to be considered an exemplification of the present invention and is not intended to limit the invention to the specific embodiments illustrated.

A system and method for tracking an object, an article, an asset or an individual as it moves along a path is disclosed hereinafter. The system and method of the present invention do not require input from an individual whenever the object or article moves from one location to another. A position indication device such as a RFID (Radio Frequency Identification), Barcode scanner, and/or GPS (Global Positioning System) device is attached directly to or located in close proximity to the article or object which is being tracked. Various types of GPS systems which are available for use include National Differential GPS System (NDGPS); Wide Area Augmentation System (WAAS); Continuously Operating Reference Station (CORS); Global Differential GPS (GDGPS); Global Navigation Satellite System (GNSS); Ground Based Augmentation System (GBAS); Assisted Global Positioning System (AGPS) (GPRS) and International GNSS Service (IGS). Other types of position indicating devices may be used in place of the RFID or GPS devices. The positioning indicating device will transmit its location utilizing GPS (Global Positioning System); GSM (Global System for Mobile communications); CDMA (Code Division Multiple Access); W-CDMA (Wideband Code Division Multiple Access) GPRS (General Packet Radio Service); EGPRS (Enhanced General Packet Radio Service); Wi-Fi enabled; 3G, 4G (third and fourth generation mobile phone standards); EDGE (an enhancement for 2G and 2.5 G GSM and GPRS networks) or SMS (Short Message Service) technologies or a combination thereof.

The system is accessed through a web site or software program wherein medical device reps, surgeons, hospital personnel, insurance providers, payment processing liaisons and surgical device manufactures can access information relating to the medical trays and their location. The trays can be ordered and transferred utilizing this web site. The costs of the trays can also be billed at this web site.

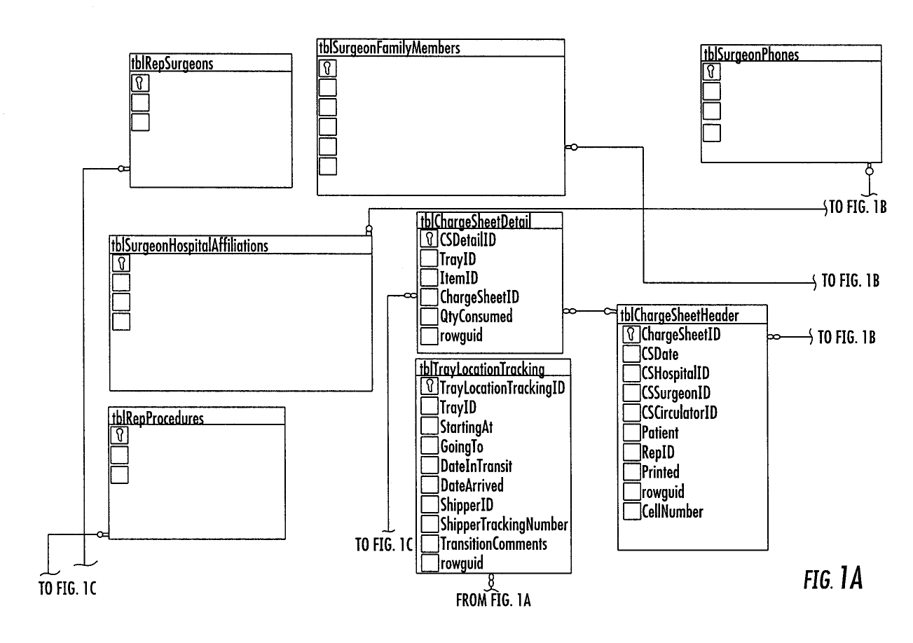

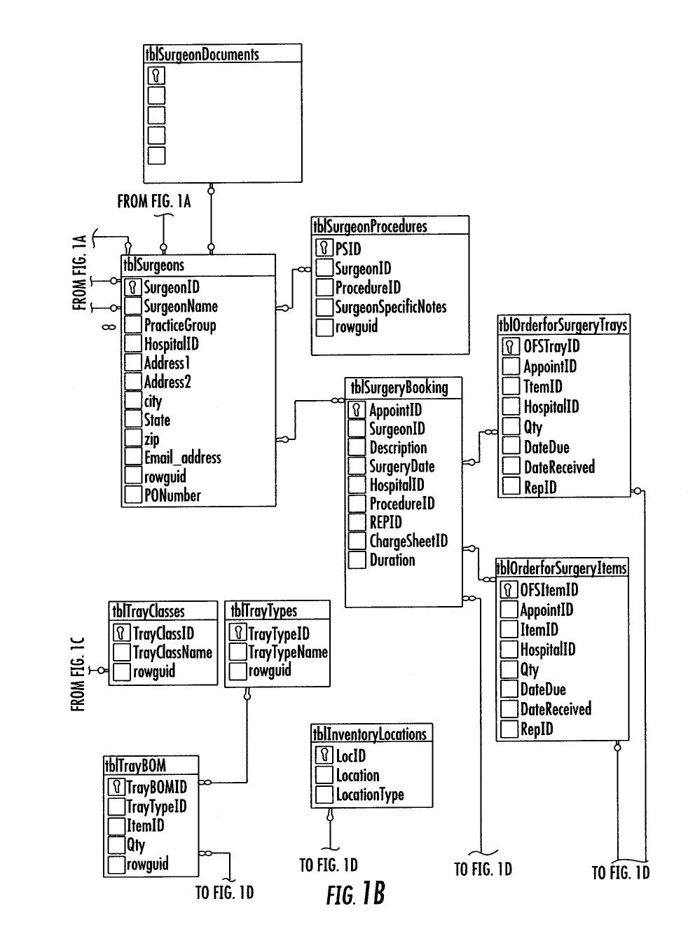

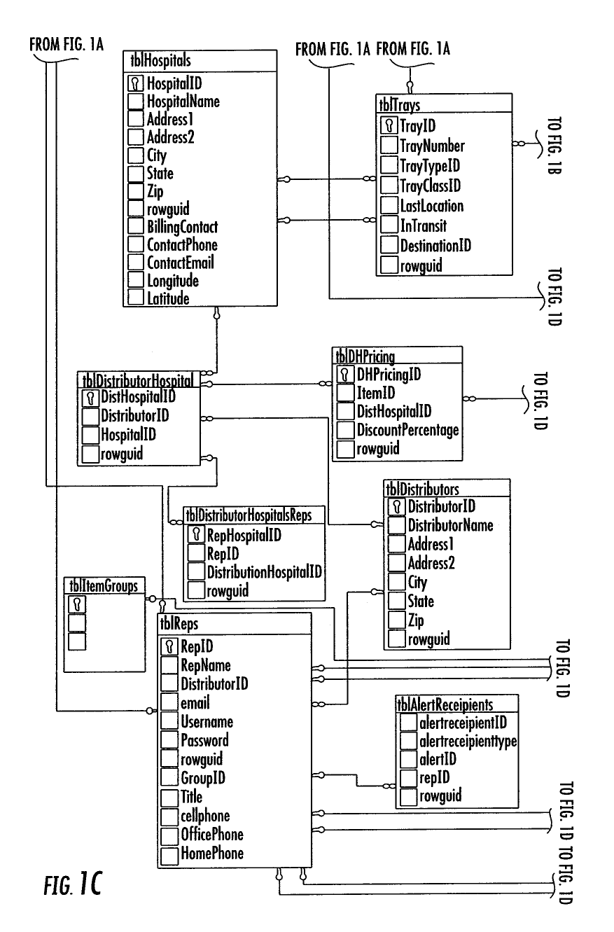

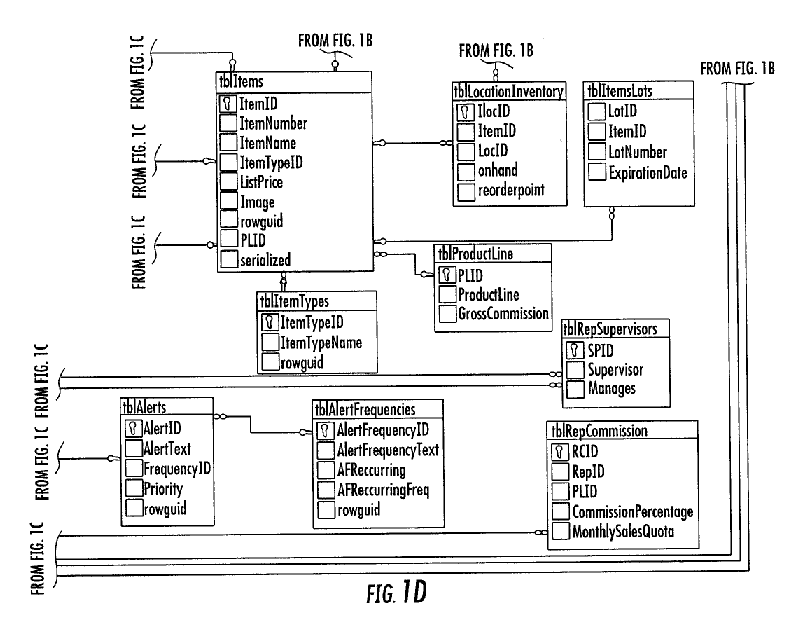

FIGS. 1 A-D illustrate how the various menus are linked to each other so that the medical device reps can access all the information pertaining to the trays and the surgical procedures in which they are to be used. The various menus illustrated in FIGS. 1 A-D include, the Rep Surgeons, the Surgeon Family Members, the Surgeon Phones, the Surgeon Documents, the Surgeon Hospital Affiliations, the Charge Detail Sheet, the Charge Sheet Header, the Surgeons, the Surgeon Procedures, the Order for Surgery Trays, the Surgical Procedures, the Tray Location Tracking, the Surgery Booking, the Hospitals, the Trays, the Tray Classes, the Tray Types, the Inventory Locations, the Order for Surgery Items, the Tray Bill of Materials, the Distributor or Hospital, the DH Pricing, the Items, the Location Inventory, the Item Lots, the Product Line, the Distributor Hospitals Reps, the Distributors, the Item Types, the Item Groups, the Reps, the Alert Recipients, the Alerts, the Alert Frequencies, the Rep Supervisors, the Rep sales reports, the Territory Manager's sales reports, the related sales quotas, and the Rep Commission.

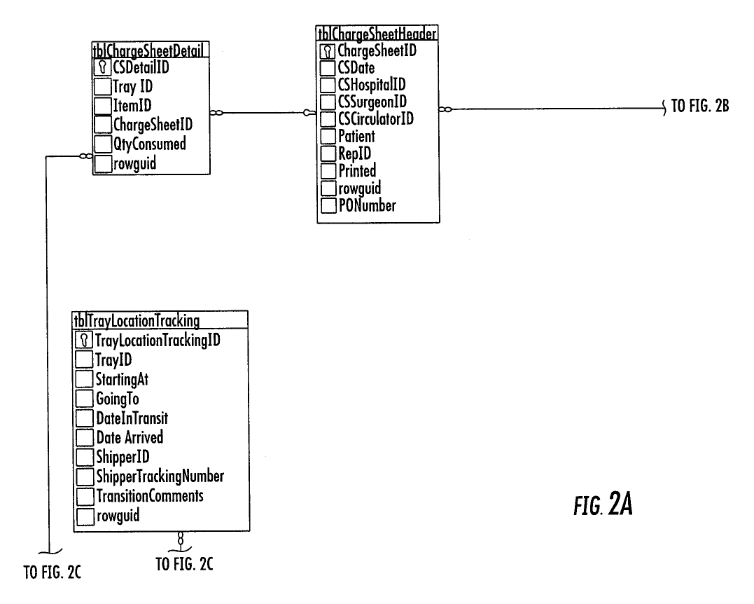

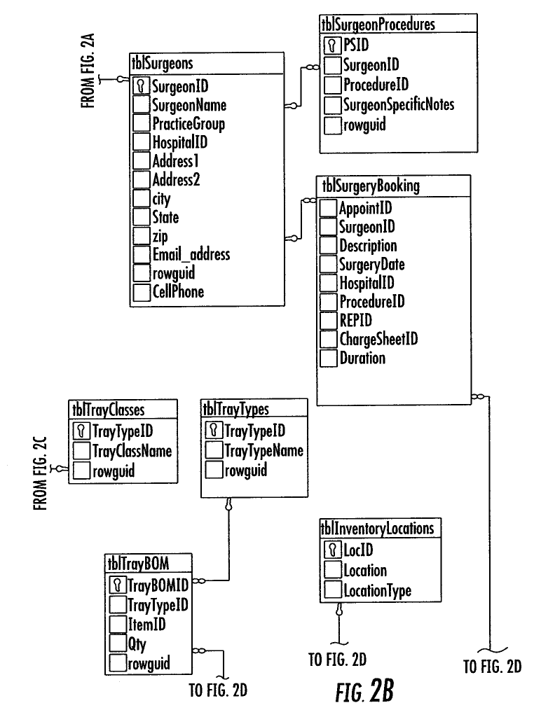

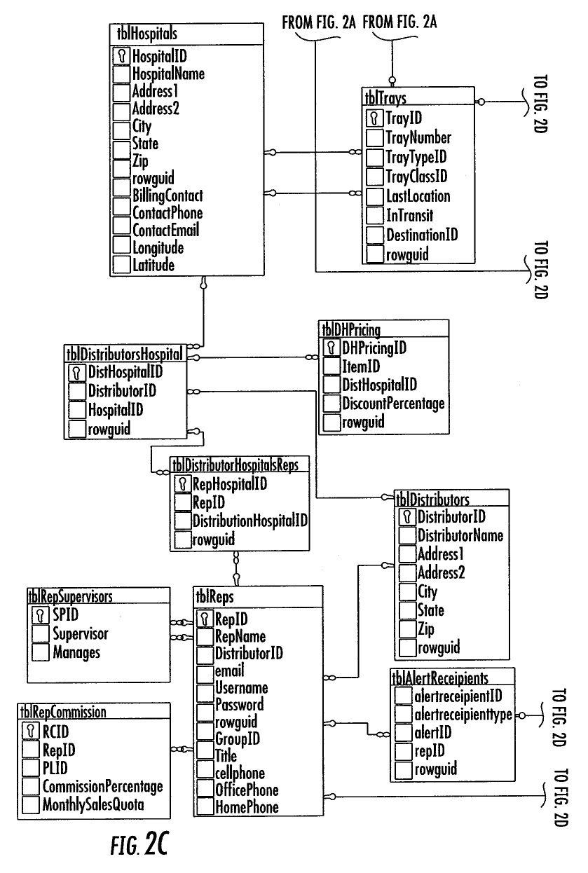

FIGS. 2 A-C also illustrate how various menus are linked to each other so that the medical device reps, financial administrators and management can access all the information pertaining to the trays and the surgical procedures in which they are to be used. The various menus illustrated in FIG. 2 include the Charge Sheet Detail, the Charge Sheet Header, the Surgeons, the Surgeon Procedures, the Surgery Booking, the Tray Location Tracking, the Hospitals, the Trays, the Tray Classes, the Tray Types, the Inventory Locations, the Tray BOM, the Distributor Hospital, the DH Pricing, the Items, the Location Inventory, the Item Lots, the Product Line, the Distributor Hospital Reps, the Distributors, the Item Types, the Rep Supervisors, the Reps, the Alert Recipients, the Alerts, the Alert Frequencies and the Rep Commission.

An example of the case coverage for different surgical procedures is illustrated in FIG. 3. For example on Monday, Sep. 10, 2007 the time and type of the procedure is listed at the top, 7:00 AM-TLIF. Next the name of the surgeon is listed, Argent Agrawal. Next the hospital where the procedure is being done is listed, North Fulton Regional Hospital. Next the name of the medial device rep. present at the procedure is listed, Jeffery Smith. Finally if the rep. is not available his replacement is listed, Jason Graves. The charge sheet menu appears in all of the web pages. This enables the user to quickly access the information that he or she is seeking.

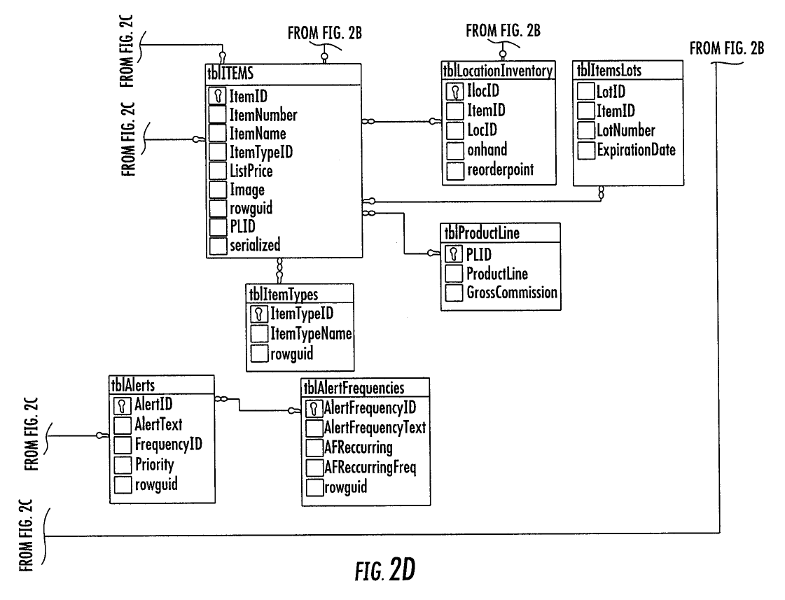

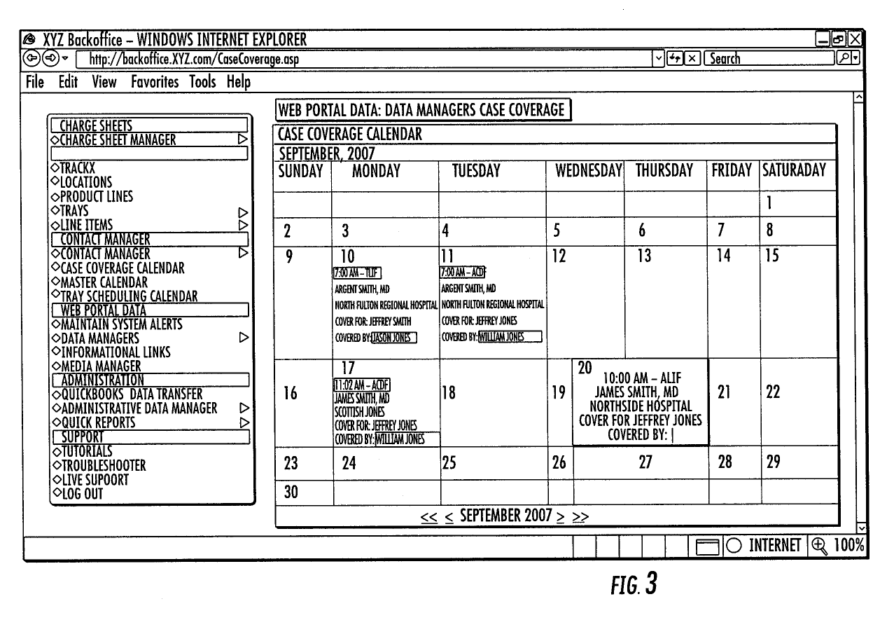

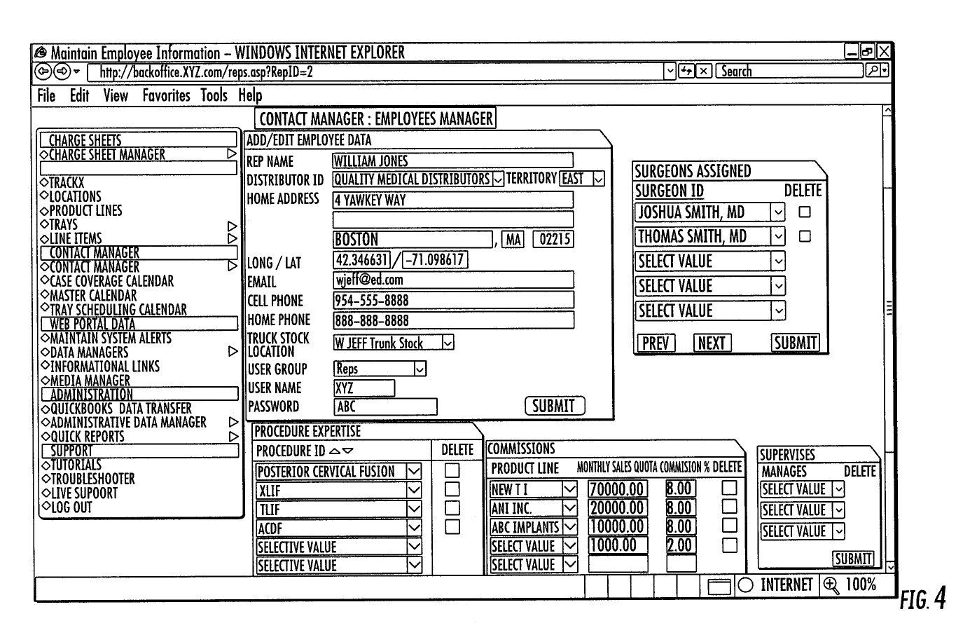

An example of the information with respect to each surgical rep. is illustrated in FIG. 4. The reps. personal information is available including how he can be contacted. The surgeons he is assigned to are also illustrated. The surgical procedures in which he has an expertise are listed. His commissions and quotas for the use of various medical devices are listed. Finally, all personal that he supervises are also listed.

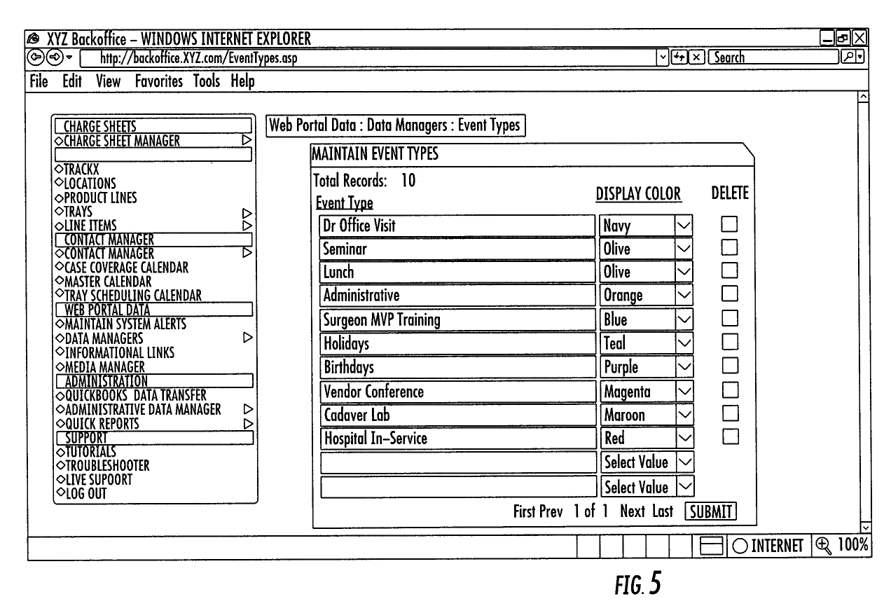

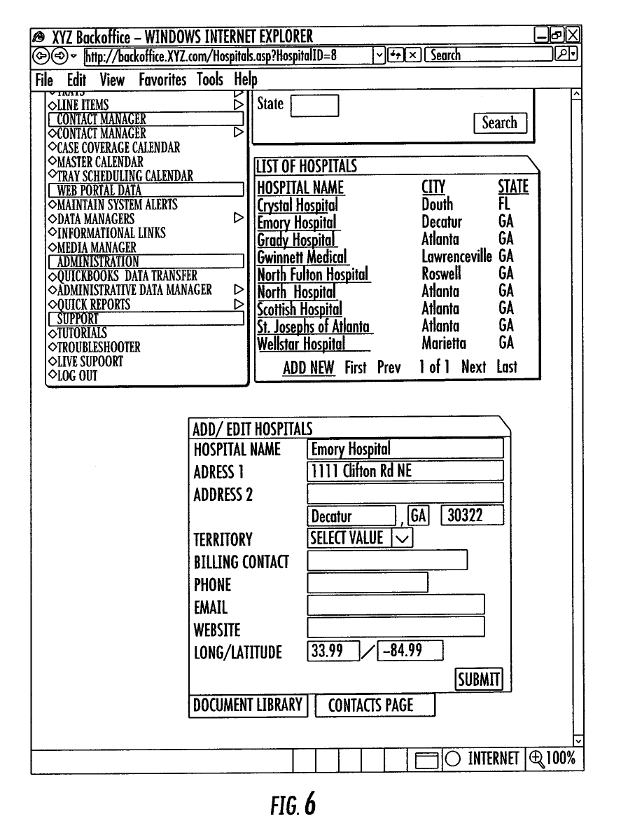

FIG. 5 is a menu of the various colors which are assigned to various events. For example, doctor visits are navy, Surgeon training is blue and hospital in-service is red. These colors are utilized in the case coverage illustrated in FIG. 3. Hospital information is illustrated in FIG. 6. A list of the hospitals which utilize the medical trays is provided. When a particular hospital is selected the address and location of the hospital is provided. Also information regarding billing is provided. Another method of accessing hospital information is illustrated in FIG. 7. The hospital or billing contact can be searched in the system. This web page also includes a quick contact information list.

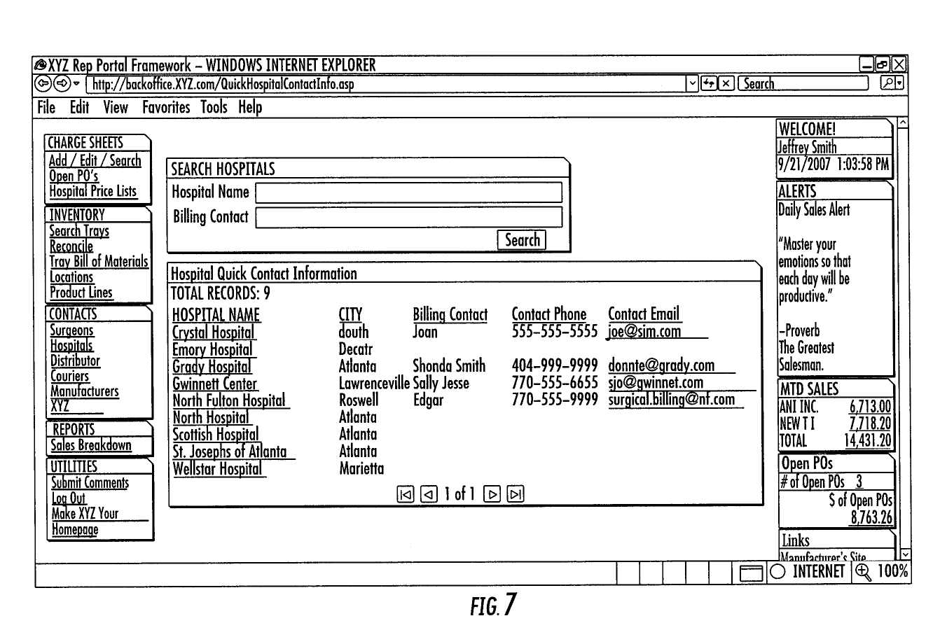

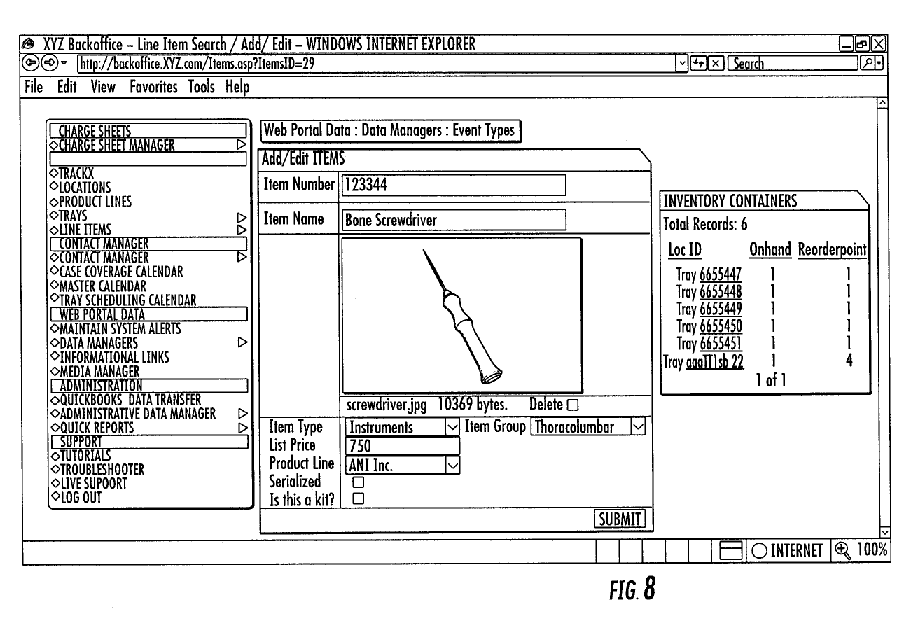

The contents of the various medical trays are illustrated in the web page in FIG. 8. A description of each of the items including a photograph, the procedure in which they are used, the cost of the items and the manufacturer are readily available. An inventory of the various trays is also available. Utilizing this information the surgical rep. can familiarize himself or herself with the contents of each tray prior to the surgical procedure.

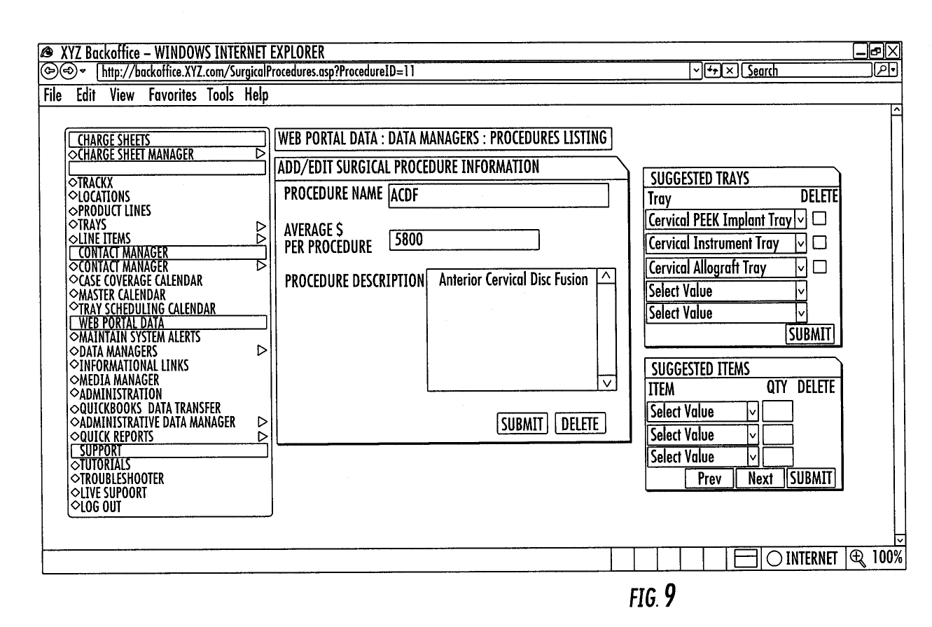

The information with respect to different surgical procedures and the medical trays required for the procedures is illustrated in FIG. 9. The rep. can select the various trays which the surgeon will need or has requested for the procedure. This information is submitted to the system to indicate the availability of the trays and if certain trays must be supplied from other locations. If this is the case then an order is placed and the required tray is shipped to the desired location.

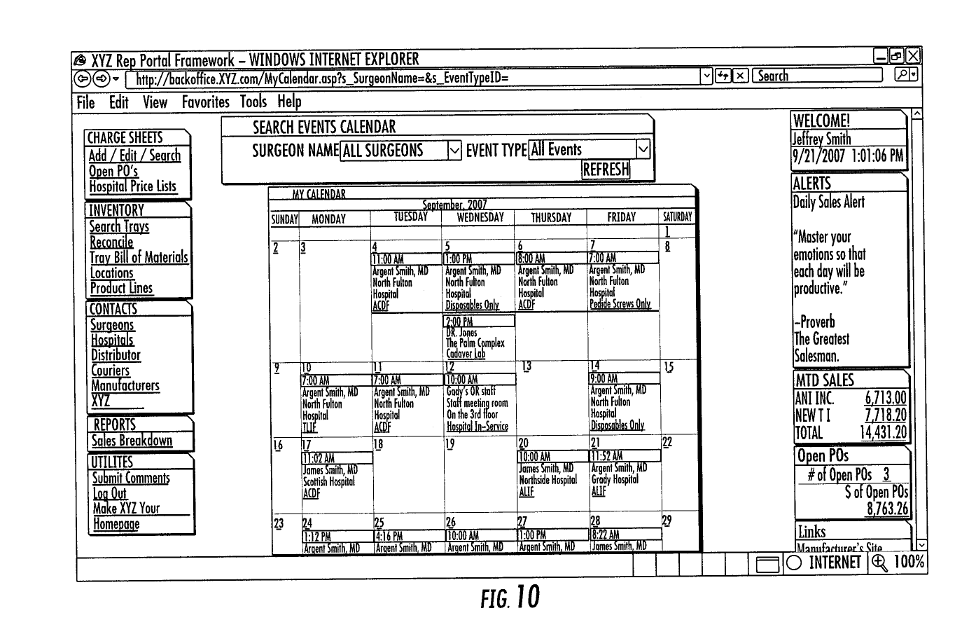

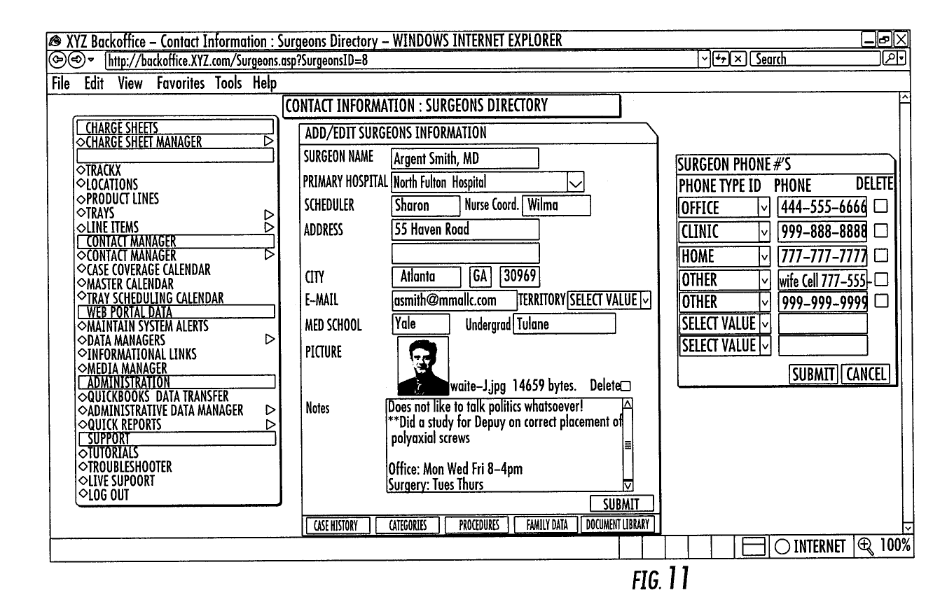

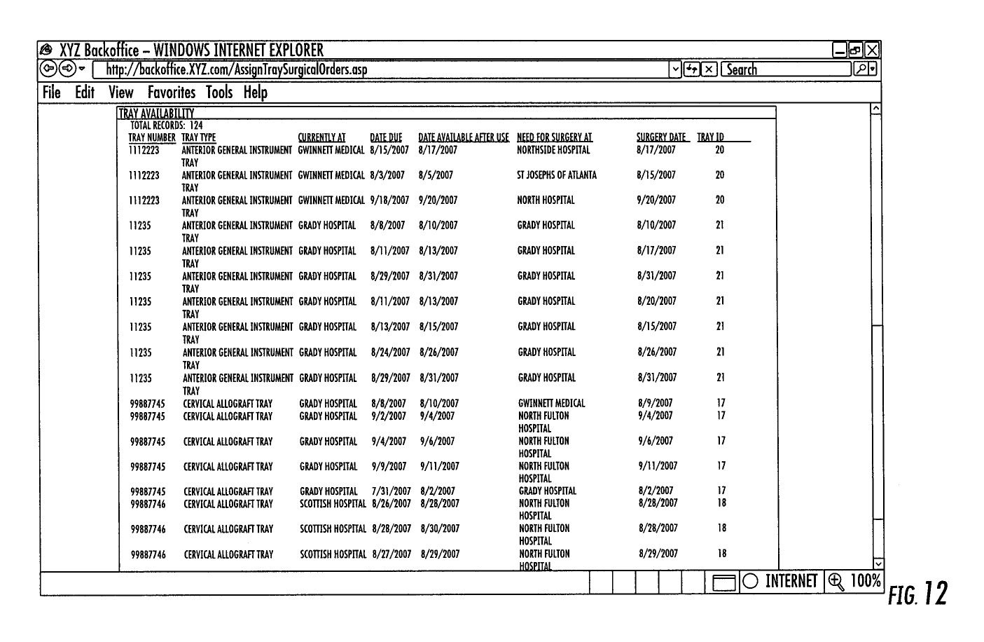

FIG. 10 illustrates a medical rep's calendar. His surgeries and other activities are on the calendar. He can also access he sales information, track the medical inventory and access information with respect to his contacts. All of this can be done where ever he has access to the Internet or the related software program. An example of the information regarding specific surgeons is illustrated in FIG. 11. With this information he is better equipped to establish a working relationship with the surgeon. Should the rep. need information regarding specific tray, he can also access this as illustrated in FIG. 12. This information includes an identification of the trays, the location of the trays, information regarding a hospital at which the tray is required, the date on which the tray is to arrive at the hospital, the date of the surgery and the date the tray will be available again if it is not needed for the surgery.

An inventory of tray orders is illustrated in FIG. 13. The date of the surgery, the surgeon's name, the specific tray required, the hospital and the rep's name assigned to the tray are provided. The rep can then locate an appropriate tray and assign it to the surgery. A list of the trays available is illustrated in FIG. 14. This information lists the specific trays, the location of the tray, if the tray has already been purchased by the hospital and any special notes regarding the tray. The notes are indicated by an icon next to the tray class.

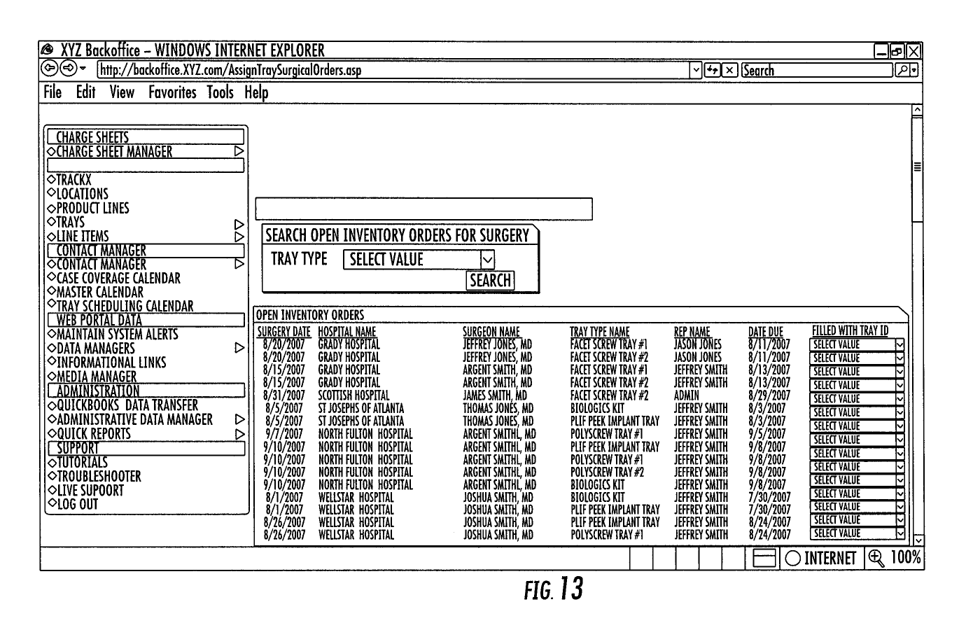

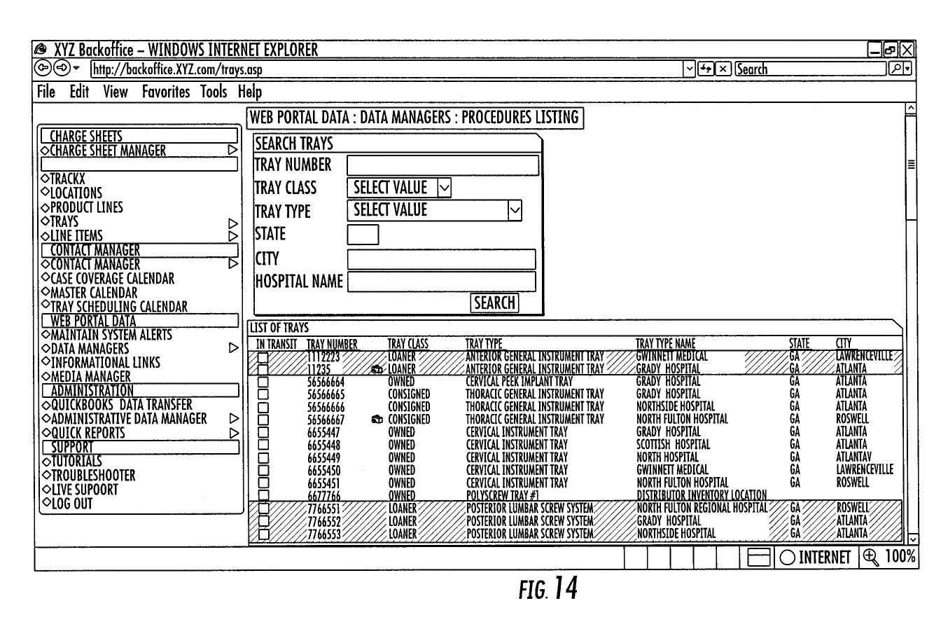

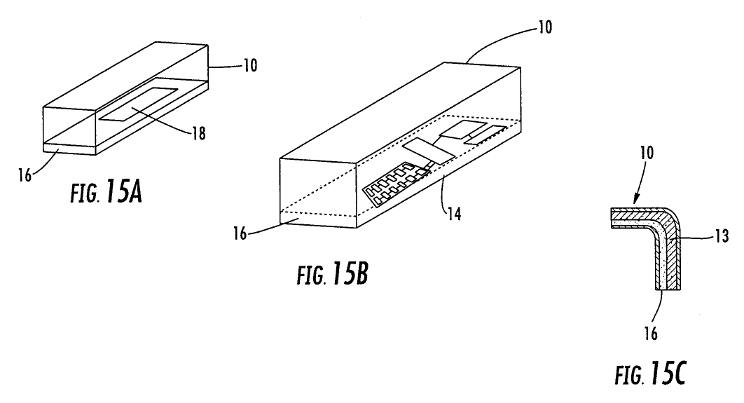

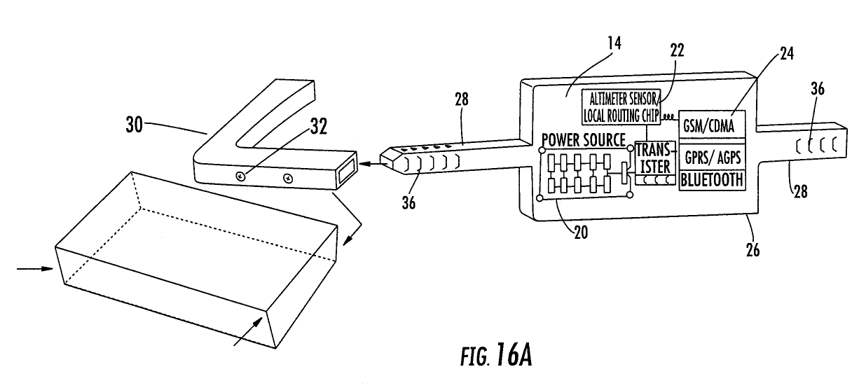

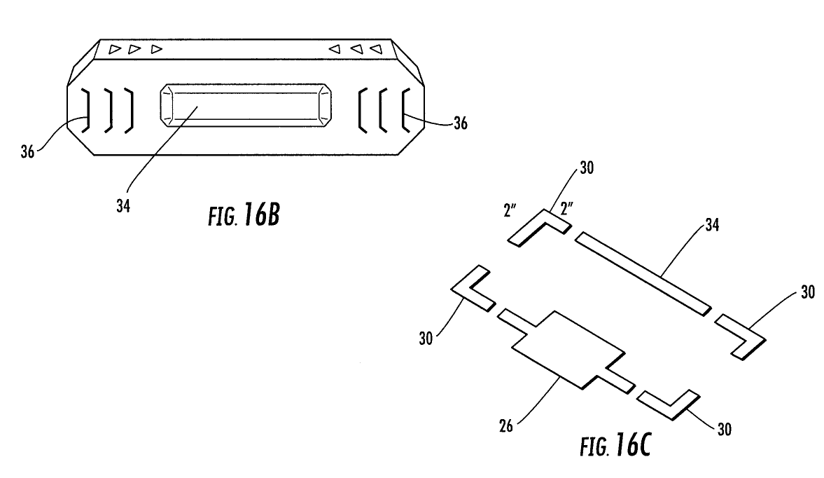

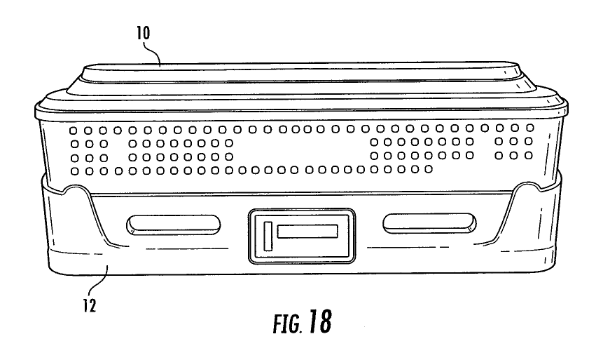

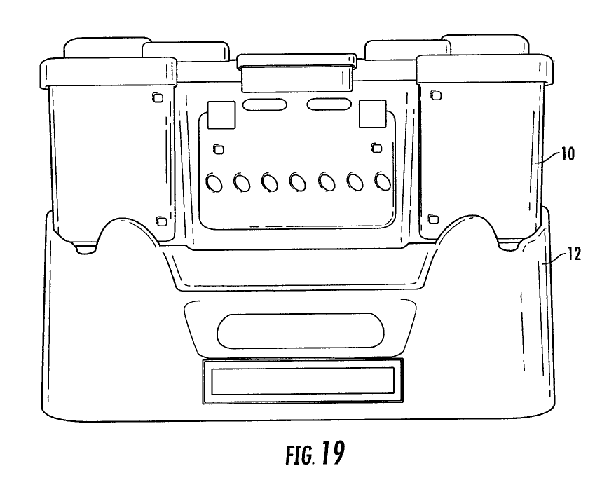

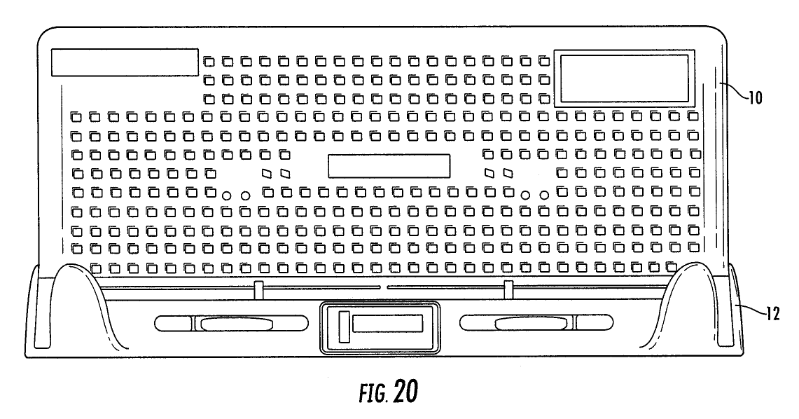

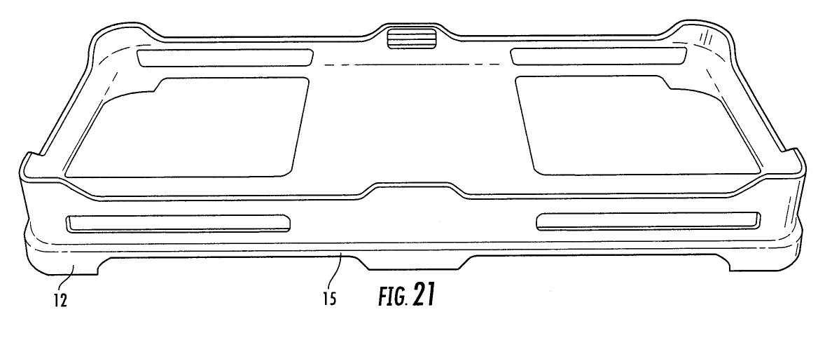

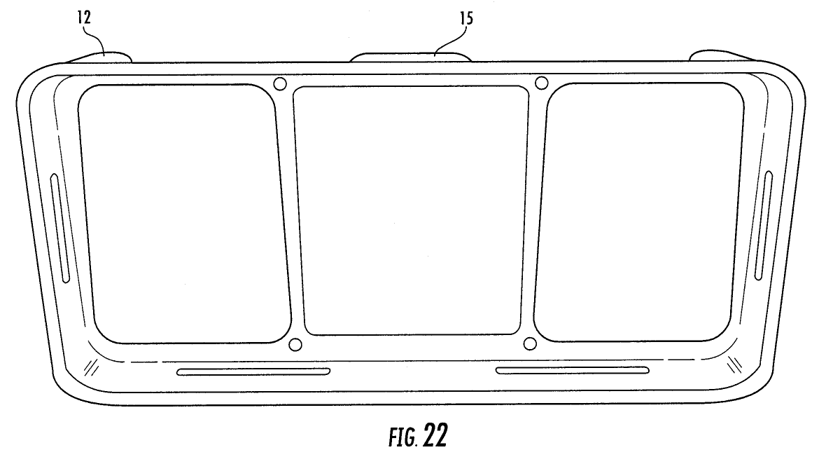

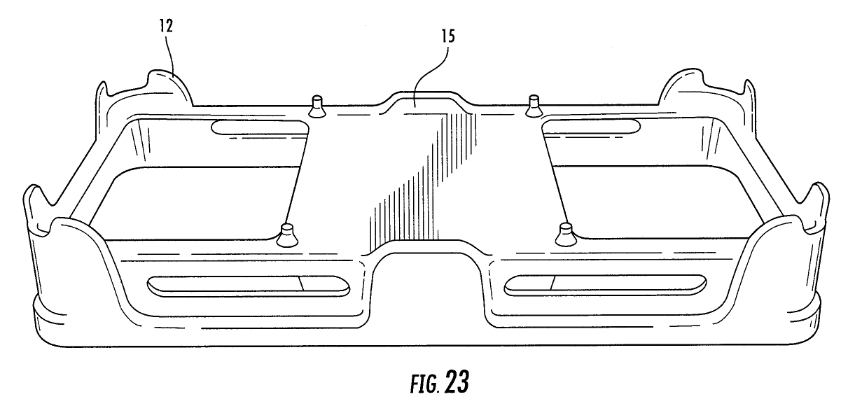

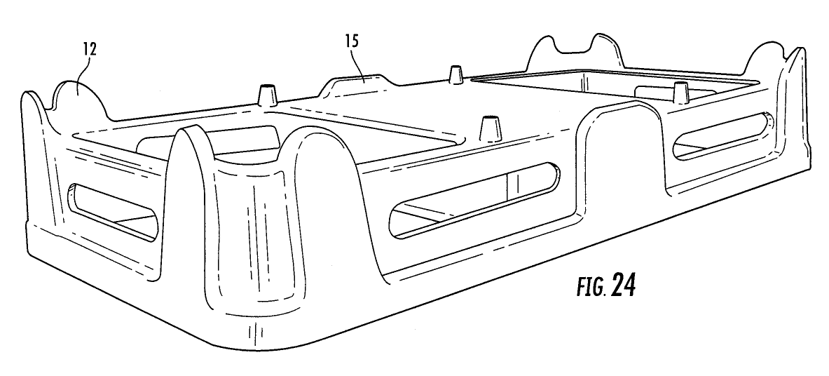

Various tracking devices for the medical trays are illustrated in FIGS. 15-23. In FIGS. 15A-C the medical tray of the present invention is indicated as 10. The medical tray normally comprises a rectangular closed box that can be considered to be a housing for sterile or non-sterile medical equipment, implants or devices. The surgical instruments (not shown) are arranged within the medical tray or box to insure proper sterilization. The tracking unit's housing is composed of a polymer, preferably a nylon-like thermo-resistant polymer exterior 13 and an interior which is preferably made of the same or a similar material. The interior and exterior can also be made of different materials. The medical tray or box can also be made or formed from other materials with properties which permit surgical/medical instruments to be housed securely therein and also permit the surgical/medical instruments to be sterilized, such as stainless steel. A tracking device 14 is located in the lower portion of the support tray, as shown in FIG. 15B. The tracking device is preferably placed in the lower portion of the support tray 12 in a silicone foam material 16. The silicone foam functions as both an insulator and a shock absorption device. The foam can be a silicone/polyamide or a silicone/polyimide. In place of this material, other materials can also be employed. The medical trays are normally sterilized at temperatures above 270° F. and the silicone foam helps protect the tracking device 14 from these high temperatures. The criteria for materials which house the tracking device is that the material maintain the tracking device dry and insulated from the heat of a sterilization process if required. Once the tracking device is placed in the lower portion of the tray 12, preferably in a compartment, an access door 18 securely closes the compartment in a manner that prohibits unauthorized personnel from accessing the tracking device. The access door is preferably provided with waterproof and heat resistant seal (not shown). The access door is preferably provided with a security sensor to notify the user if the door has been opened (not shown). The access door is preferably equipped with a water breach sensor that notifies the user if the waterproof seal has been breached and needs to be replaced and sent in for maintenance (not shown). The tracking device utilizes a power supply which is also contained with the compartment. The power supply is preferably a battery, but can be any other source that supplies the required power. The access door is used for battery replacement in the power supply and maintenance or replacement of the tracking device. The tracking device 14 generally illustrated in FIG. 16A can be employed in all of the various embodiments of the present invention. The tracking device 14 comprises a power source 20, a motion sensor 22, and a communicator 24 which utilizes GSM, GPRS, CDMA, Wi-Fi and/or Bluetooth, AGPS methods and SMS protocol to communicate the location of the medical tray. An individual seeking the location of the medical tray can establish contact with the tracking device with their mobile phone. The tracking device will then indicate the location of the medical tray. This type of communication system permits the tracking of medical trays inside of buildings where GPS devices will not function. The tracking units can also communicate with each other in a similar fashion in order to relay data. The tracking units can also communicate with each other using Wi-Fi in order to help conserve the battery in another unit is having difficulty relaying its location. The individual's mobile communication device or another communication device such as the web-based system or software can be programmed to ping the tracking device at regular intervals. This helps conserve the batteries in the power supply of the tracking device. The motion sensor 22 triggers the communicator 24 when ever the medical tray is moved.

A second embodiment of the tracking device is illustrated in FIGS. 16 A-C. This tracking device is secured around the outer periphery of the medical tray. This is known as the “Halo” design. The tracking device is located in the main element 26 of the device. The tracking device includes a motion sensor 22, a power supply 20 and a communicator 24. An access door or panel (not shown) provides access to the tracking device to enable battery replacement or other operations. The access door cannot be readily accessed by unauthorized personnel and is normally located on the rear side of the main element 26. The main element 26 is provided with legs or extensions 28. These legs connect to corner elements 30. The legs are secured to the corner elements utilizing rivets or other fasteners 32. A connection member 34 secures corner elements together, as illustrated in FIG. 16C. The corner elements 30 are designed to connect to each other when they are secured to a conventional sized medical tray. Connection members 34 can also be utilized to connect corner elements 30 to each other whenever the width of the medical tray is larger than normal. A connection member 34 is illustrated in FIG. 16B. The connection member 34 is provided with zip-tie like one way connectors 36 at both ends of the connection member. These connectors allow the connection member to be inserted into the corner elements but not withdrawn therefrom. After these elements have been connected to each other, additional fasteners such as rivets 32 are also used to secure the elements together. Connectors 36 are also provided on the main element 26 as illustrated in FIG. 16A. The medical tray may or may not be formed from the same material as the tray of the embodiment of FIGS. 15 A-C. Thermo resistant foam can also be utilized in the main element to protect the tracking device.

A third embodiment of the tracking device is illustrated in FIG. 17. The tracking device is positioned in a housing 40 which is secured to an outer portion of a medical tray 10 which can be any side, top, or bottom of the tray or container. Straps 42 secure the housing 40 to the medical tray. Rivets 44 or similar fasteners secure the straps 42 to the medical tray. The fasteners are designed so they are not removable by unauthorized personnel. An access door or panel (not shown) provides access to the interior of housing 40 for battery replacement or access to the tracking device. The medical tray is formed from the same material as the tray of the embodiment of FIGS. 15 A-C. Thermo resistant foam and silicone rubber layers can also be utilized in the housing 40 to protect the tracking device.

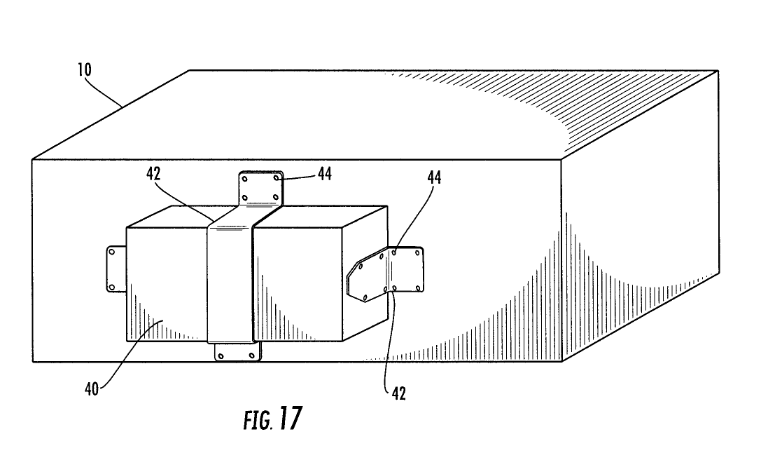

A fourth embodiment of the tracking device is illustrated in FIGS. 18-22. As illustrated in FIGS. 18-20 a medical tray or asset 10 is secured onto a support 12. In this embodiment the medical tray or asset 10 is separate from and not integral with the support 12. The medical tray or asset 10 can be secured to the support 12 with any appropriate means. The support 12 includes a compartment 15 which contains a tracking device 14 which enables an individual to locate and track the movement of the support 12 and asset 10 that is secured to the support.

The location of the tray or asset is preferably determined in a number of ways. The tray or asset can be provided with a RFID tag which can be tracked. The tray or asset can also be provided with a bar code label which can be scanned and the location information sent to a main server of the tracking system. The tray or asset can be provided with a Wi-Fi communicator which will send the location of the tray of asset via the Internet to a main server of the tracking system. Finally, the tray or asset can be provided with a CDMA/AGPS/GPRS/GSM communication device which will communicate the location of the tray or asset to a main server of the tracking system. This can also be accomplished by utilizing a Geo-fence surrounding the location.

Alternatively, the positioning indicating device on the tray or asset can transmit the location of the tray or asset utilizing GPS (Global Positioning System); GSM (Global System for Mobile communications); CDMA (Code Division Multiple Access); W-CDMA (Wideband Code Division Multiple Access); GPRS (General Packet Radio Service); EGPRS (Enhanced General Packet Radio Service); Wi-Fi enabled; 3G, 4G (third and fourth generation mobile phone standards); EDGE (an enhancement for 2G and 2.5 G GSM and GPRS networks); SMS (Short Message Service) technologies; Bluetooth technologies; or a combination of the above mentioned technologies to a main server of the tracking system or location where all the information regarding all of the trays or assets being monitored is retained and stored. This main server can be accessed by authorized individuals, hospitals, industry regulators, insurance providers, companies and other entities. The information pertaining to the individual medical/surgical trays, their contents and locations is utilized to quickly and correctly supply individuals, such as doctors, and institutions, such as hospitals, with the proper medical/surgical trays containing the items they need. This information is also employed to track the location of specific trays or items within trays. It can also be used to redirect items from one location to another when a specific item is needed quickly. It can also be used to stop contaminated biologics or faulty products in-transit from being delivered or used by the end user. Further, the individuals using the items can be billed for their use by detecting that certain items have been removed from trays or that certain trays have been opened, etc.

Compartment 15 also contains a Radio Frequency Identification Transponder (RFIDT). The RFID transponder communicates with RFID tags that are secured onto each of the individual items within the medical tray or asset 10. Normally one RFID tag is secured to each individual item in tray 10. However, certain items are too small to have an RFID tag secured thereto. In these situations the items may be grouped together and one RFID tag secured to the group of items. Also the items can be placed in a container, such as a bag, which is large enough to have a RFID tag secured thereto. This enables the RFIDT to take an inventory of all of the items contained within the tray or asset 10 and communicates with the Internet or software program through the unit's Wi-Fi, CDMA, PAS or GSM components.

Subsequent to taking an inventory of all of the items within the tray or asset 10 this information is transmitted to a server which stores this information. Transmission to the server is accomplished by one or more of the following: a RFID reader or Polling Acquisition System (PAS); a Wi-Fi communication system or a CDMA system with AGPS (assisted GPS), GPRS or GSM. When a RFID reader or a PAS is employed, the RFIDT transmits the data obtained from the RFID tags within the tray or asset to the RFID reader or PAS. The PAS or RFID reader is normally located within the same room or building in which the medical trays or assets are being stored. From there it is transmitted to the main server of the tracking system that contains all of the information regarding the entire system. Subsequent to the PAS or RFID reader acquiring information regarding the contents of the tray 10, the PAS or RFID reader sends this information via a communicator 24 (see FIG. 16A), to the main server of the tracking system or other similar device. Other types of position indicating devices may be used in place of the RFID or GPS devices.

Alternatively, Wi-Fi can be employed. Many facilities including hospitals currently provide Wi-Fi service for individuals to communicate using their portable or mobile computers. Each of the individual Wi-Fi locations or hot spots has their own IP address. The information regarding the tray or asset is then sent via the Internet to the main server of the tracking system. In addition to the hospital, other locations such as a STARBUCKS®, a Barnes and Noble book store, a vehicle equipped with Wi-Fi service or a location or hot spot within a city or town that has Wi-Fi service can be utilized to transmit the information regarding the contents and location of a tray or asset from its current location to the main server. This same technology can be utilized to transmit information from one Wi-Fi location to another. For example, the location and contents of the tray or asset can be transmitted from the tray which includes a Wi-Fi chipset as a means of communication via a Wi-Fi in a vehicle to a Wi-Fi hot spot in a town or business and then to the main server. This same information can relay the hotspot or location's IP address as a checkpoint and inform the user of its location at the time of data transmittal.

Alternatively, transmission of the data via CDMA can be employed. The contents of the tray or asset and the location of the tray or asset can be transmitted via CDMA to the main server of the tracking system. CDMA can use assisted GPS (AGPS), GPRS or GSM.

An inventory of the contents of a medical tray enable a medical representative to indicate which items have been used or damaged in a given medical tray. For example, when item number 5 has been used in a surgery it needs to be replaced. When an inventory of the contents of the tray is performed, as indicated above, the inventory indicates that item number 5 is missing the medical; representative confirms this on his/her PDA or cell phone and a request is immediately sent to a supplier for a replacement for item number 5. Also, when a message from a medical representative is received that item number 5 is damaged, a request for a replacement for item number 5 is sent to a supplier.

However, whenever there is a discrepancy, only the item that is confirmed to be missing by the medical representative is charged for but all missing items will be replenished. For example, if an inventory of the tray indicates that items 5 and 6 are missing, but the medical representative has indicated that only item 5 has been used then only item 5 is charged for. A physical inspection of the medical tray must then be performed to determine if item 6 is present in the tray. If item 6 is not present in the tray it must be determined if item 6 has been misplaced, lost or stolen. The doctor or hospital that has used the medical tray will not be billed for item 6 until it can be positively determined that the doctor or hospital has used the item.

The RFID transponders, Wi-Fi communicators or CDMA communicators do not have to be on or operating all of the time to properly perform their jobs. Once a medical tray or asset has arrived at a location where it will be stored until it is needed, the tray or asset does not need to be constantly tracked. The location of the tray or asset is sent to the main server or other location where the trays or assets are being monitored and the location will remain the same until the tray or asset is moved. Therefore these tracking or location devices can be turned off or placed in a “sleep mode” whenever their use, for a period of time, is not required. Turning off these devices or placing them in a sleep mode, when they are not required, helps extend the life of the batteries which supply power to these devices. Thus, the less frequently the RFID transducer, Wi-Fi communicators or CDMA communicators are used the longer they can stay within a tray or asset and not require maintenance or battery replacement. If the tracking unit leaves the location and passes the respective Geofence then the unit will be awakened and begin to transmit location in its regular set intervals according to the times set by the end user in the web-based system or software's schedule.

Another situation where the RFID transducer and communicators should be turned off, to conserve power, is when they are unable to communicate with the system which tracks the trays or assets. An example of this situation is when the tray or asset is being transported in an air craft. When the tray or asset is off the ground and in the air they are not able to communicate with the tracking system. They cannot establish cellular communications or other types of communications. While it is important to track the tray or asset to the airport to assure that it has arrived and it ill be flown to the next destination, the tracking devices should not be turned off until is can be correctly ascertained that the tray or asset is in the air. This can be accomplished by employing an altimeter sensor or switch, or similar device which measures the height of an object relative to the earth, and connecting it to the tracking devices. The tracking devices can be programmed to be turned off once the altimeter indicates a preset altitude, such as 6,000 ft., thus saving the batteries. The tracking devices can be turned on again once the altimeter sensor or switch indicated that the tray or asset has returned below the preset altitude.

In addition to employing the Wi-Fi facilities and services aforementioned, the Wi-Fi service currently provide within or soon to be provided within aircraft can be utilized in a manner similar to the ground based Wi-Fi service to track the location of the asset or medical tray and also provide an individual with information regarding the contents, status and location of an asset or medical tray. In this situation the aircraft would have its own IP address so as to function in a manner similar to that of a hospital equipped with Wi-Fi. An individual could track an aircraft utilizing its flight number, among other things. The departure and arrival time of the asset or medical tray would then be instantaneously available to anyone with access to the tracking system of the asset or medical tray. Further, if the flight was delayed for any reason, this information would also be available to those with access to the system. This would greatly aid “just in time” inventory management. This type of tracking could also be incorporated into the luggage which the airlines carry. If an individual were to become separated from their luggage because of delays in aircraft departures or takeoffs, the individual or airline could readily and accurately determine the exact location of the individual's luggage and arrange for it to be shipped to the correct location.

Individuals could also tag their clothing or other items with RFID tags to determine if someone has tampered with their luggage. This could also be employed for homeland security to assure that items which have been registered and cleared are placed back into the appropriate luggage from which they came during luggage sweeps which occur behind closed doors.

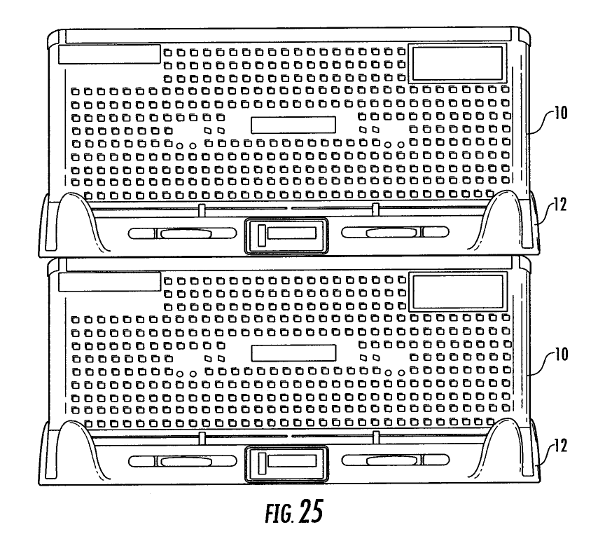

FIG. 25 illustrates two medical trays or assets stacked one above the other. Stacking of the trays or assets during transportation is a common occurrence. The present invention includes a stacking non-slip feature which prevents the stacked trays or assets from separating or falling during transportation.

In addition to tracking medical trays and their contents the tracking device and system can also be used to track documents, automobiles, automobile parts, jewelry, cargo, freight, animals, people, movie equipment, luggage, artillery, weapons, packages which are shipped and require confirmation of receipt, shipping totes, items which require delivery and confirmation of delivery, pallets, airplane and airplane parts, helicopter and helicopter parts, computers and computer parts, tools and tool boxes, boats and boat parts, food, produce, retail goods, clothing and related accessories, art and valuable antiquities.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A tracking system comprising:
at least one transmitting device located in at least one object to be tracked;
a receiver for receiving signals from said at least one transmitting device;
said signals including information with respect to the location of said at least one object to be tracked, information regarding identification of said at least one object and information regarding contents of said at least one object;
said tracking system including information regarding the intended use of said at least one object; said system enabling a user to arrange delivery of said at least one object to a location where said object is to be utilized; and
said system further including a control device constructed and arranged to activate and deactivate said at least one transmitting device.

2. The tracking system of claim 1 wherein said at least one transmitting device is selected from the group consisting of GPS (Global Positioning System); GSM (Global System for Mobile communications); CDMA (Code Division Multiple Access); W-CDMA (Wideband Code Division Multiple Access); GPRS (General Packet Radio Service); EGPRS (Enhanced General Packet Radio Service); Wi-Fi; 3G, 4G (third and fourth generation mobile phone standards); EDGE (an enhancement for 2G and 2.5 G GSM and GPRS networks); SMS (Short Message Service) and Bluetooth.

3. The tracking system of claim 1 wherein one of said transmitting devices is a RFID (Radio Frequency Identification Device).

4. The tracking system of claim 1 wherein one of said transmitting devices is a Wi-Fi enabled device.

5. The tracking system of claim 1 wherein said control device is constructed and arranged to activate and deactivate all of said transmitting devices.

6. The tracking system of claim 1 wherein information regarding an intended user of said object is retained in said system.

7. The tracking system of claim 1 wherein information regarding the user of said system is retained in said system.

8. The tracking system of claim 1 wherein information regarding the location of said at least one object and other intended locations of said at least one object is retained in said system.

9. The tracking system of claim 1, wherein said object is a medical device.

10. The tracking system of claim 6 wherein said intended user is a doctor.

11. The tracking system of claim 1 wherein said object is a medication.

12. The system of claim 1 wherein said object is a patient.

13. The system of claim 1 wherein said user is a representative of a medical device manufacturer.

14. The system of claim 13 wherein said representative can order specific medical devices.

15. A tracking device for an object comprising;
at least one transmitting device located proximate at least one object to be tracked;
at least one receiver receiving signals from said at least one transmitting device;
said signals including information with respect to the location of said at least one object to be tracked, information regarding the identification of said at least one object and information regarding the contents of said at least one object; and
said receiver including a control device to activate and deactivate said at least one transmitting device.

16. The tracking device of claim 15 wherein said at least one transmitting device is selected from the group consisting of GPS (Global Positioning System); GSM (Global System for Mobile communications); CDMA (Code Division Multiple Access); W-CDMA (Wideband Code Division Multiple Access); GPRS (General Packet Radio Service); EGPRS (Enhanced General Packet Radio Service); Wi-Fi; 3G, 4G (third and fourth generation mobile phone standards); EDGE (an enhancement for 2G and 2.5 G GSM and GPRS networks); SMS (Short Message Service) and Bluetooth.

17. The tracking device of claim 15 wherein one of said transmitting devices is a RFID (Radio Frequency Identification Device).

18. The tracking device of claim 15 wherein one of said transmitting devices is a Wi-Fi enabled device.

19. The tracking device of claim 15 wherein said control device is constructed and arranged to activate and deactivate all of said transmitting devices.

20. The tracking device of claim 15 wherein thermal insulation is provided adjacent said at least one transmitting device.
